(19) United States
(12) Patent Application Publication
(10) Pub. No.: US 2025/0088944 A1
(43) Pub. Date: Mar. 13, 2025

(54) SYSTEM AND METHOD FOR SYNCHRONIZING NETWORK SLICE PROVISIONING CHANGES

(71) Applicant: Verizon Patent and Licensing Inc., Basking Ridge, NJ (US)

(72) Inventors: Samirkumar Patel, Middlesex, NJ (US); Balaji L. Raghavachari, Bridgewater, NJ (US); Lily Zhu, Parsippany, NJ (US)

(21) Appl. No.: 18/463,580

(22) Filed: Sep. 8, 2023

(51) Int. Cl. H04W 48/08; H04W 60/00

(52) U.S. Cl. CPC H04W 48/08; H04W 60/00

(57) ABSTRACT

A device may forward, to a User Equipment device (UE) over a network, an updated list of subscribed network slices; receive, from the UE, a registration request that includes a list of requested network slices; generate, based on the list of requested network slices, an updated list of allowed network slices; and send the updated list of allowed network slices to the UE. The updated list of allowed network slices may be synchronized to the updated list of subscribed network slices.

### BACKGROUND INFORMATION

To satisfy the needs and demands of users of mobile communication devices, providers of wireless communication services continue to improve and expand their networks. One aspect of such improvements includes the development of core networks and options to utilize such core networks. A provider may operate a core network that manages a large number of user devices using different types of core network components. Managing different types of services using multiple technologies poses various challenges.

### BRIEF DESCRIPTION OF THE DRAWINGS

FIGS. 1A-1C illustrate concepts described herein;

FIG. 2 illustrates an exemplary network environment in which systems and methods described herein may be implemented;

FIG. 3 depicts example components of a User Equipment device (UE) according to an implementation;

FIG. 4 illustrates a portion of a core network according to an implementation;

FIG. 5 is a flow diagram of an exemplary process for synchronizing a list of allowed network slices with a list of subscribed network slices at a UE, according to an implementation;

FIG. 6 is a messaging diagram that is associated with a process for synchronizing a list of allowed network slices with a list of subscribed network slices at a UE, according to an implementation;

FIG. 7 is a flow diagram of an exemplary process for synchronizing a list of allowed network slices with a list of subscribed network slices at a UE, according to another implementation;

FIG. 8 is a messaging diagram that is associated with a process for synchronizing a list of allowed network slices with a list of subscribed network slices at a UE, according to another implementation; and

FIG. 9 depicts exemplary functional components of a network device according to an implementation.

### DETAILED DESCRIPTION

The following detailed description refers to the accompanying drawings. The same reference numbers in different drawings may identify the same or similar elements.

Systems and methods described herein relate to synchronizing network slice provisioning changes. According to the Third Generation Partnership Project (3GPP) standards, when a slice provisioning subscription changes, a stand-alone (SA) Fifth Generation core network (5GC) provides to the User Equipment device (UE) only the identities of newly updated list of subscribed network slices. The 5GC may provide the identities by issuing to the UE a Configuration Update Command (CUC) message via a Non-Access Stratum connection over the SA network. However, the 5GC is not required to provide updated identities of allowed network slices, which the 5GC may have selected from network slices to which the user was previously subscribed. Therefore, at the UE, the stored list of allowed network slices may no longer be consistent with, and may be out-of-sync with, the list of currently subscribed network slices.

The out-of-sync condition may persist, as the 3GPP does not require the Configuration Update Command to trigger the UE re-register or provide mobility registration updates (MRU) that will lead to its list of allowed network slices to become synchronized with its list of subscribed network slices. In some use case scenarios, even if the UE were required to re-register, if the UE has moved out of the coverage area of the SA portion of the network, the UE may be unable to re-register at the SA portion of the network and synchronize its lists of allowed and subscribed network slices.

If a UE's list of allowed and subscribed network slices are out-of-sync, the UE may be unable to apply its UE Route Selection Policy (URSP) rules to correctly identify the network slices to which it may establish Protocol Data Unit (PDU) sessions. Consequently, the UE may be unable to receive the particular service or the Quality-of-Service (QOS) level the network slice is to deliver (e.g., an ultra-reliable low latency communication (URLLC) service for gaming). The systems and methods described herein address the out-of-sync condition of a UE's lists of allowed and subscribed network slices and permit the UE to receive its services from the correct network slices.

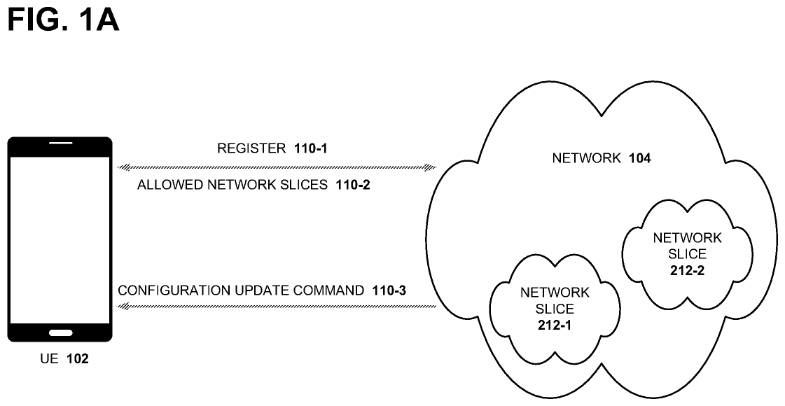

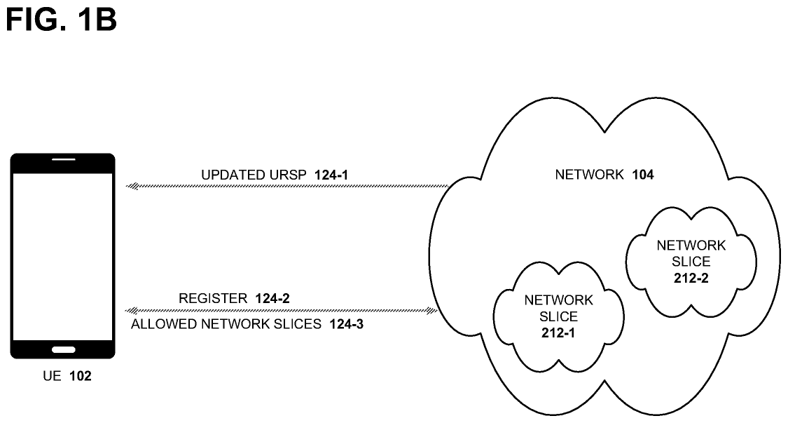

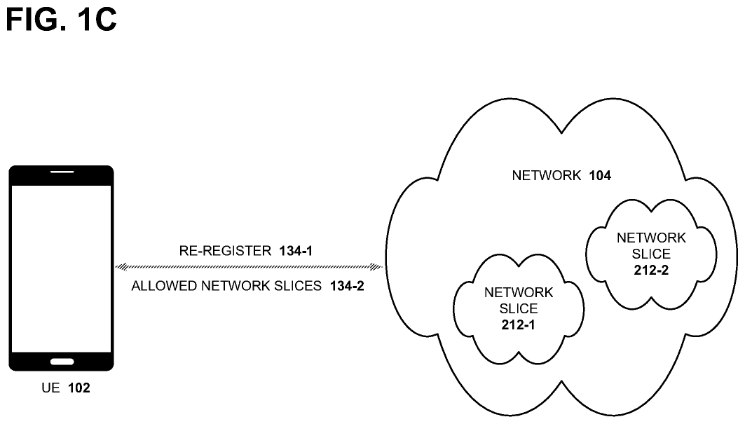

FIGS. 1A-1C illustrate the concepts described herein. FIG. 1A depicts how lists of allowed and subscribed network slices can become out-of-sync. In FIG. 1A, a UE 102 registers (110-1) with a 5G SA portion of a provider network 104 (e.g., a cellular network). UE 102 receives a list of allowed network slices (110-2). The list identifies a network slice 212-1 as an allowed network slice. Assume that the user of UE 102 upgrades his or her service with provider network 104, which results in the user subscribing to a network slice 212-2, which may deliver a higher quality service than network slice 212-1 to UE 102. Network 104 sends a Configuration Update Command (110-3) that informs UE 102 that network 104 has recognized the user is subscribed to network slice 212-2; however, network 104 does not provide an updated list of allowed network slices to UE 102.

When UE 102 is about to request a PDU session, UE 102 evaluates its URSP rules to identify the network slice to which it intends to connect. However, because UE 102's list of allowed network slices (e.g., network slice 212-1) is out-of-sync with its list of subscribed network slices (e.g., network slices 212-1 and 212-2), UE 102 is unable to identify network slice 212-2 as the correct network slice with which UE 102 should establish a PDU session, and thus, requests a PDU session with network slice 212-1. Thus, UE 102 may be unable to receive its services from network slice 212-2.

FIG. 1B illustrates one of the systems for synchronizing lists of allowed and subscribed network slices to address the issue depicted in FIG. 1A. In this implementation, components of the system may be included in UE 102 and/or network 104. In FIG. 1B, after a Configuration Update Command (see FIG. 1A) has been sent by network 104 to UE 102, a network portion of the system generates an updated URSP rule that, if evaluated by UE 102, may cause UE 102 to produce a list of “requested network slices”-a list that UE 102 may submit to network 104 during its registration. Network 104 may then send the updated URSP rule to UE 102 (124-1).

Assume that UE 102 moves out of the coverage area of network 104. When UE 102 returns to the coverage area, UE 102 may prepare to register at network 104. In particular, UE 102 may evaluate the updated URSP rule, identify any network slice specified by the rule but not in its lists of allowed and/or subscribed network slices, and update its list of requested network slices based on the evaluation. UE 102 may then forward the updated list of requested network slices along with its registration request to network 104 (124-2). When network 104 is about to issue a registration accept message to UE 102 in response to the registration request, network 104 may generate an updated list of allowed network slices based on the list of requested network slices. Network 104 may output and send the registration accept message to UE 102 along with the updated list of allowed network slices (124-3). UE 102 may receive and store the list-thus synchronizing its lists of allowed and subscribed network slices.

FIG. 1C illustrates another one of the systems for synchronizing lists of allowed and subscribed network slices to address the issue depicted in FIG. 1A. In this implementation, components of the system may be included in UE 102 and/or network 104. In FIG. 1C, after a Configuration Update Command (see FIG. 1A) has been sent by network 104 to UE 102, a UE portion of the systems may determine that the Configuration Update Command from the network 104 identifies a newly subscribed network slice, generate a new list of requested network slices, and cause UE 102 to re-register with network 104 (134-1), submitting the requested list. Network 104 may then generate an updated list of allowed network slices based on the requested list and forward registration accept message along with the updated list of allowed network slices to UE 102 (134-2). UE 102 may receive and store the updated list of allowed network slices, thus synchronizing its lists of allowed and subscribed network slices.

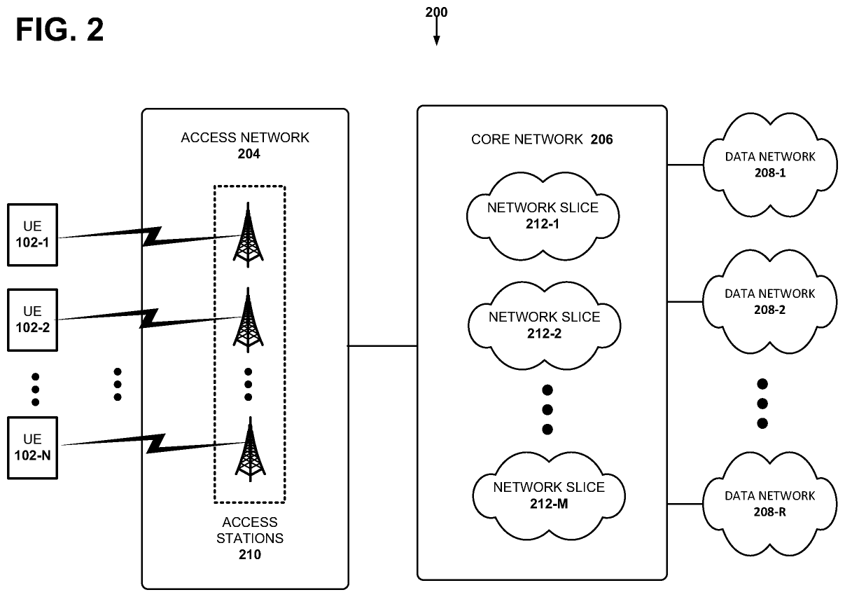

FIG. 2 illustrates an exemplary network environment 200 in which the systems and methods may be implemented. As shown, environment 200 may include UEs 102-1 through 102-N (collectively referred to as UEs 102 and generically referred to as UE 102), an access network 204, a core network 206, and data networks 208-1 through 208-R (collectively referred to as data networks 208 and generically referred to as data network 208). Access network 204, core network 206, and data networks 208 may be part of provider network 104 (not shown in FIG. 2).

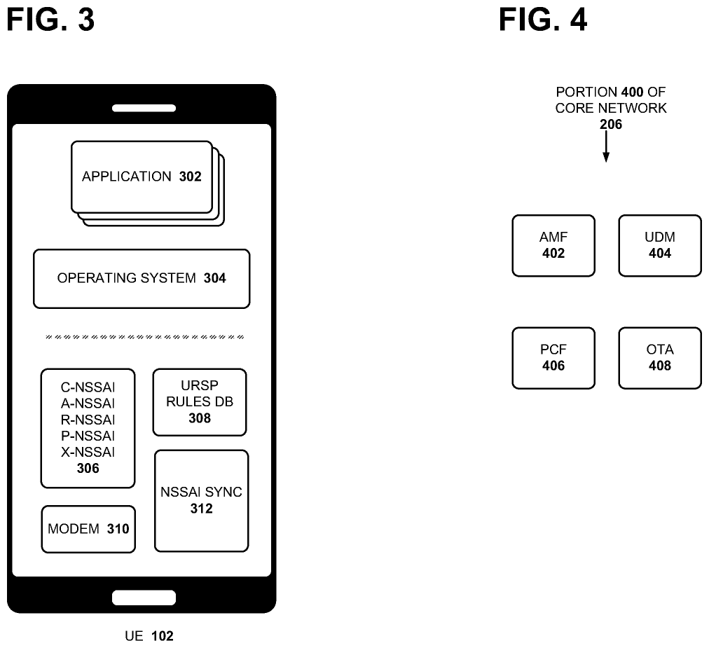

UEs 102 may include wireless communication devices capable of 5G New Radio (NR) communication. Some UEs 102 may additionally include Fourth Generation (4G) (e.g., Long-Term Evolution (LTE)) communication capabilities. Examples of UE 102 include: a smart phone; a tablet device; a wearable computer device (e.g., a smart watch); a global positioning system (GPS) device; a laptop computer; a media playing device; a portable gaming system; an autonomous vehicle navigation system; a sensor, such as a pressure sensor; a Fixed Wireless Access (FWA) device; a Customer Premises Equipment (CPE) device, with or without Wi-Fi® capabilities; and an Internet-of-Things (IoT) device. In some implementations, UE 102 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices. UEs 102 may include one or more components that are part of the system for synchronizing its lists of allowed and subscribed network slices. These components are described below with reference to FIG. 3.

Access network 204 may allow UE 102 to access core network 206. To do so, access network 204 may establish and maintain, with participation from UE 102, an over-the-air channel with UE 102; and maintain backhaul channels with core network 206. Access network 204 may relay information through such channels, from UEs 102 to core network 206 and vice versa. Access network 204 may include an LTE radio network and/or a 5G NR network, or another advanced radio network. These networks may include many central units (CUs), distributed units (DUs), radio units (RUs), and wireless stations, some of which are illustrated in FIG. 2 as access stations 210 (herein generically referred to as access station 210) for establishing and maintaining over-the-air channel with UEs 102. In some implementations, access station 210 may include a 4G, 5G, or another type of base station (e.g., eNB, gNB, etc.) that comprises one or more radio frequency (RF) transceivers. In some implementations, access station 210 may be part of an evolved Universal Mobile Telecommunications Service (UMTS) Terrestrial Radio Access Network (eUTRAN).

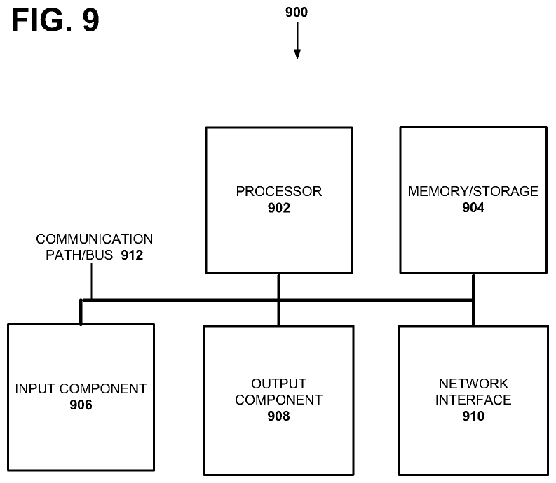

Core network 206 may manage communication sessions of UEs 102 connecting to core network 206 via access network 204. For example, core network 206 may establish an Internet Protocol (IP) connection between UEs 102 and data networks 208. The components of core network 206 may be implemented as dedicated hardware components or as virtualized functions implemented on top of a common shared physical infrastructure using Software Defined Networking (SDN). For example, an SDN controller may implement one or more of the components of core network 206 using an adapter implementing a virtual network function (VNF) virtual machine, a Cloud Native Function (CNF) container, an event driven server-less architecture interface, and/or another type of SDN component. The common shared physical infrastructure may be implemented using one or more devices 900 described below with reference to FIG. 9 in a cloud computing center associated with core network 206. Core network 206 may include 5G core network components, 4G core network components, and/or another type of core network components (e.g., 6G core network components). Some of 5G core network components that may include part of the system for synchronizing lists of allowed and subscribed network slices are described below with reference to FIG. 4.

As further shown, core network 206 may include one or more network slices 212-1 through 212-M (herein collectively referred to as network slices 212 and generically as network slice 212). Depending on the implementation, network slices 212 may be implemented within other networks, such as access network 204 and/or data network 208. Access network 204, core network 206, and data networks 208 may include multiple instances of network slices 212. Each network slice 212 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport, Central Processing Unit (CPU) cycles, memory, etc. Furthermore, each network slice 212 may be configured to meet a different set of requirements and may be associated with a particular QoS class, a type of service, 5G QOS Identifier (5QI), and/or a particular group of enterprise customers associated with communication devices. Network slices 212 may be capable of supporting enhanced Mobile Broadband (eMBB) traffic, Ultra Reliable Low Latency Communication traffic, Time Sensitive Network (TSN) traffic, Massive IoT (MIOT) traffic, Vehicle-to-Everything (V2X) traffic, High performance Machine Type Communication (HMTC) traffic, and other customized traffic, for example.

Each network slice 212 may be associated with an identifier, herein referred to as a Single Network Slice Selection Assistance Information (S-NSSAI) and/or a network slice instance ID. Each UE 102 that is configured to access a particular network slice may be associated with corresponding subscription data, stored in core network 206 for example, which includes the S-NSSAI corresponding to the network slice. NSSAI may refer to a set of S-NSSAIs or just multiple S-NSSAIs.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, an LTE network), an ad hoc network, a telephone network (e.g., the Public Switched Telephone Network (PSTN) or a cellular network), an intranet, or a combination of networks. Data network 208 may include an application server (also referred to as application). An application may provide services for a program or an application running on UE 102 and may establish communication sessions with UE 102 via core network 206.

For clarity, FIG. 2 does not show all components that may be included in network environment 200 (e.g., routers, bridges, wireless access point, additional networks, data centers, portals, etc.). Depending on the implementation, network environment 200 may include additional, fewer, different, or a different arrangement of components than those illustrated in FIG. 2. Furthermore, in different implementations, the configuration of network environment 200 may be different.

FIG. 3 depicts example components of UE 102 according to an implementation. As shown, UE 102 may include one or more of application 302, an operating system 304, NSSAI lists 306, URSP rules database (DB) 308, a modem 310, and NSSAI sync logic 312. Depending on the implementation, UE 102 may comprise other components or different components than those illustrated in FIG. 3.

Application 302 may include one or more software programs that run on UE 102. Application 302 may operate in conjunction with another program, also referred to as an application, in network 104, in network slice 212, or in data network 208. Application 302 may include or be associated with a traffic descriptor. A traffic descriptor may include an app ID, a fully qualified domain name (FQDN), a DNN, etc. A traffic descriptor may indicate a type of traffic that application 302 may exchange over a connection that it establishes with network slice 212 or data network 208 (e.g., a video stream, an audio stream, Internet traffic, etc.).

When application 302 initiates a connection to a network slice 212 or data network 208, application 302 may invoke a call to lower layers of the system in UE 102, through operating system 304, to modem 310. Once the connection is established with a component in network 104, application 302 may communicate with the component (e.g., send data or receive data) over the connection.

Operating system 304 may manage applications 302, services, memory, and/or other resources on UE 102. Additionally, as indicated above, operating system 304 may relay connection requests from application 302 to modem 310 and relay messages, whose destinations are applications 302, which arrive at modem 310 from network 104 to application 302.

NSSAI lists 306 may include different types of NSSAI or S-NSSAIs. Although herein referred to as “NSSAI lists 306,” NSSAI lists 306 may not literally refer to lists but to NSSAI and S-NSSAIs stored in various parts of UE 102. More specifically, referring to FIG. 3, NSSAI lists 306 may include subscribed NSSAI (C-NSSAI) (also referred to as configured NSSAI), allowed NSSAI (A-NSSAI), requested NSSAI (R-NSSAI), picked/selected NSSAI (P-NSSAI), and rejected NSSAI (X-NSSAI). C-NSSAI may identify network slices to which the UE is subscribed. C-NSSAI may include at most 16 S-NSSAIs, one of which includes a default S-NSSAI. A-NSSAI may include a set of S-NSSAIs that identify network slices 212 with which UE 102 may establish a PDU session. A-NSSAI may include a subset of S-NSSAIs included in the C-NSSAI. R-NSSAI may include a set of S-NSSAIs that UE 102 requests network 104 for approval during its registration. P-NSSAI may include NSSAI that network 104 or UE 102 selects from the R-NSSAI provided by UE 102 to network 104. X-NSSAI may include NSSAI that UE 102 submitted to network 104 as part of R-NSSAI but network 104 rejected,

URSP rules DB 308 may include URSP rules. Each URSP rule in URSP rule DB 308 may include a traffic descriptor and one or more rule descriptors. When a URSP rule is applied based on matching a traffic descriptor included in a connection request from application 302 to a traffic descriptor in the URSP rule, one of the rule descriptors may identify a network slice 212 (i.e., a S-NSSAI). When network 104 sends updated URSP rules to UE 102, modem 310 may store the updated URSP rules in URSP rules DB 308. Furthermore, modem 310 may access URSP rules DB 308 when modem 310 has to look up a URSP rule whose traffic descriptor matches the traffic descriptor in the connection request received by modem 310 from application 302 via operating system 304.

Modem 310 may perform communication-related functions, including establishing connections and/or sessions between UE 102 and network 104, delivering messages from/to UE 102 to/from network 104, perform modulation/demodulation, perform signal processing, etc. When modem 310 receives a connection request from applications 302 via operating system 304, modem 310 may extract a traffic descriptor from the request. Next, modem 310 may apply a URSP rule that matches the traffic descriptor to identify the network slice 212 or data network 208 to which the connection is to be established from the application 302. Thereafter, modem 310 may establish the connection to the identified network slice 212 or the identified data network 208.

NSSAI sync logic 312 may include a program or hardware component for having UE 102 synchronize its C-NSSAI with A-NSSAI. In one implementation, when UE 102 arrives in the coverage area of an SA portion of network 104 (e.g., UE 102 wakes from the airplane mode or moves from a non-SA portion of network 104 to the SA portion), prior to performing registration or a Mobility Registration Update (MRU), UE 102 may evalute the updated URSP rules received from network 104, comparing NSSAI identified by the evaluated URSP rules to its A-NSSAI and C-NSSAI. If there is any NSSAI, specified in the updated URSP rule, which is not in the A-NSSAI or C-NSSAI, UE 102 may update its R-NSSAI with the NSSAI identified in the URSP rule. When UE 102 registers at the SA portion of network 104, UE 102 may submit the R-NSSAI. UE 102 may receive a registration accept message along with an updated A-NSSAI.

In addition, NSSAI sync logic 312 may be configured to cause UE 102 to re-register when UE 102 receives a Configuration Update Command that provides an update to the C-NSSAI. When UE 102 re-registers at network 104 and submit its updated R-NSSAI, UE 102 may receive its updated A-NSSAI along with the registration accept message from network 104.

FIG. 4 illustrates a portion of core network 206, according to an implementation. As shown, portion 400 of core network 206 may include an Access and Mobility Management Function (AMF) 402, a Unified Data Management and/or a Unified Data Repository (collectively herein referred to as UDM 404), a Policy Control Function (PCF) 406, and an Over-the-AIR server (OTA) 408. Each of components 402-408 may include one or more network devices 900 (FIG. 9) or be implemented on one or more network devices 900. Depending on the implementation, portion 400 may include additional, fewer, and/or different 5G core network components than those illustrated in FIG. 4.

AMF 402 may perform registration management, connection management, reachability management, mobility management, lawful intercepts, Short Message Service (SMS) transport between UE 102 and a Short Message Service Function (SMSF), session management messages transport between UE 102 and the SMF, access authentication and authorization, location services management, functionality to support non-3GPP access networks, and/or other types of management.

To support synchronization of the A-NSSAI and C-NSSAI at UE 102, AMF 402 may be configured to cause, in response to updating the C-NSSAI at UE 102 via a Configuration Update Command, or to initiate an update to URSP rules at UE 102. In addition, in some implementations, after AMF 402 issues a Configuration Update Command to UE 102 to update its C-NSSAI at UE 102, AMF 402 may signal UE 102 to re-register at network 104. In other implementations, AMF 402 may not signal UE 102 to re-register, as UE 102 includes logic to re-register at network 104 when UE 102 receives a Configuration Update Command from network 104 to update the C-NSSAI at UE 102.

UDM 404, as indicated above, may refer to a combination of a UDM and a UDR. UDM 404 may maintain subscription data for UEs 102, manage subscriptions, generate authentication credentials, handle user identification, perform access authorization based on subscription data, perform network function registration management, maintain service and/or session continuity by maintaining assignment of the SMF for ongoing sessions, support SMS delivery, support lawful intercept functionality, and/or perform other processes associated with managing user data. The UDR part of UDM 404 may store information that the UDM manages. The subscription data that UDM 404 manages/stores may include a list of subscribed network slices (i.e., NSSAI for the subscribed network slices-C-NSSAI). If there are any changes to the list of subscribed network slices for a particular UE 102 and AMF 402 queries UDM 404 for subscription data, UDM 404 may convey to AMF 402 any changes to its list of subscribed network slices.

PCF 406 may support policies to control network behavior, provide policy rules to control plane functions (e.g., to the SMF), access subscription data relevant to policy decisions, perform policy decisions, and/or perform other types of processes associated with policy enforcement. To support the system for synchronizing the A-NSSAI and C-NSSAI at UE 102, PCF 406 may be configured to generate and send a policy that instructs AMF 402 to send a notification to PCF 406 when AMF 402 sends UE 102 an update to the C-NSSAI via a Configuration Update Command. When AMF 402 sends a notification that indicates a Configuration Update Command updating the C-NSSAI at UE 102 has been sent to UE 102, in response, PCF 404 may generate a new URSP rule (for the UE 102) corresponding to the changes to network slice subscription. PCF 404 may then forward the generated/updated URSP rule to OTA 408, instructing OTA 408 to download the updated URSP rule to UE 102.

OTA 408 may perform an over-the-air download of programs, content, rules, etc., to UE 102 (e.g., via access network 204). For example, OTA 408 may download an updated URSP rule to UE 102. Although OTA 408 is depicted as being included in portion 400 of core network 206, in other implementations, OTA 408 may be included in other portions of network 104, such as access network 204 or data network 208.

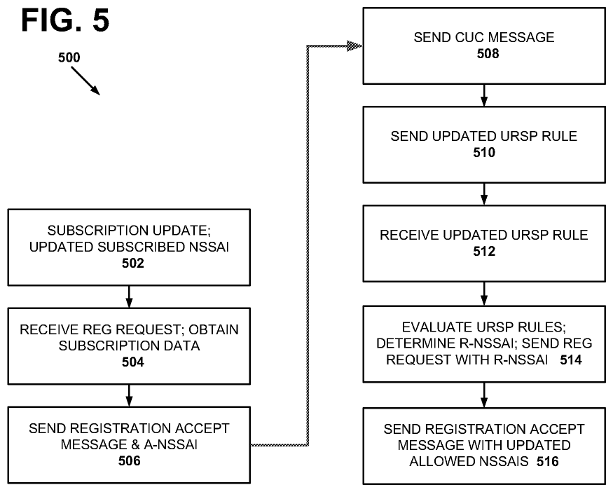

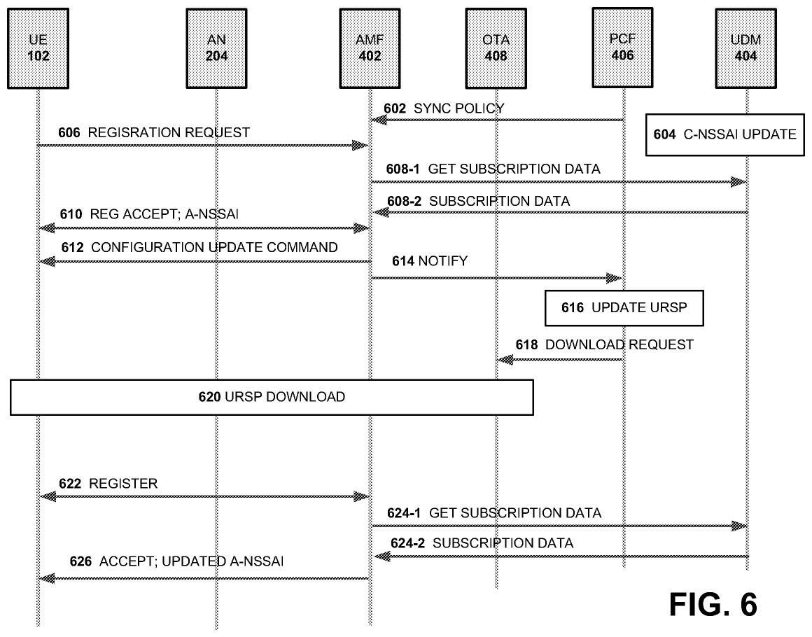

FIG. 5 is a flow diagram of an exemplary process 500 for synchronizing the A-NSSAI and C-NSSAI at UE 102, according to an implementation. FIG. 6 is a messaging diagram which is associated with process 500. FIG. 6 is described below in connection with FIG. 5. Process 500 may be performed by one or more components and devices of the system for synchronizing the A-NSSAI with the C-NSSAI at UE 102. Assume that PCF 406 has sent a policy message to AMF 402, instructing AMF 402 to notify PCF 406 when AMF 402 updates the C-NSSAI at UE 102 via a Configuration Update Command (FIG. 6: arrow 602). As shown in FIG. 5, process 500 may include updating user subscription data at UDM 404 (block 502). The subscription update may include changes in the identities of network slices 212 to which UE 102 is subscribed and network slices to which UE 102 is unsubscribed (block 502; block 604 of FIG. 6).

Process 500 may further include AMF 402 receiving a registration request from UE 102 (block 504; arrow 606). In response to the receipt, AMF 402 may send a request for subscription data to UDM 404 and obtain subscription data from UDM 404 (block 504; arrows 608-1 and 608-2). The subscription data may include an S-NSSAI or NSSAI that captures any changes to identities of subscribed network slices. Thereafter, assuming that any authentication of UE 102 for the registration is successful, AMF 402 may send a registration accept message, along with A-NSSAI to UE 102 (block 506; arrow 610).

Process 500 may further include AMF 402 sending a Configuration Update Command message to UE 102 (block 508; arrow 612). That is, when AMF 402 receives any changes to the identities of subscribed network slices for UE 102, AMF 402 may notify UE 102 of the change, sending the Configuration Update Command, along with the C-NSSAI. AMF 402 may then notify PCF 406 that a Configuration Update Command that reflects changes to the C-NSSAI has been sent to UE 102 (arrow 614). In response, PCF 406 may generate an updated URSP rule for UE 102 (block 616). The updated URSP rule may reflect any changes to the C-NSSAI. Furthermore, PCF 406 may send the updated URSP rule to UE 102 (block 510). For example, PCF 406 may send a request to download the updated URSP rule to OTA 408 (arrow 618), which may then download the updated URSP rule to UE 102 over the user plane (block 620). As a result, UE 102 may receive the updated URSP rule (block 512; block 620) and store the received URSP rule in URSP rule DB 308.

After the receipt of the updated URSP rule, UE 102 may become engaged in activities that may require UE 102 to re-register at network 104. For example, UE 102 may be powered down; or enter an airplane mode. Later, when UE 102 is within the coverage area of the SA portion of network 104, UE 102 may initiate its registration procedure. As part of the registration procedure, UE 102 may determine anew its requested NSSAI or R-NSSAI by evaluating its updated URSP rules (block 514). Next, UE 102 may send a registration request along with the updated R-NSSAI to network 104 (block 514; arrow 622). When AMF 402 receives the registration request, AMF 402 may obtain subscription data for UE 102 from UDM 404 (arrows 624-1 and 624-2).

After AMF 402 obtains the subscription data, AMF 402 may generate updated A-NSSAI based on the subscription data and R-NSSAI from UE 102. When AMF 402 sends the registration accept message to UE 102, AMF 402 may also send the updated A-NSSAI (block 516; arrow 626). UE 102 may then receive the registration accept message and the updated A-NSSAI. UE 102 may the updated A-NSSAI to synchronize its A-NSSAI with the C-NSSAI.

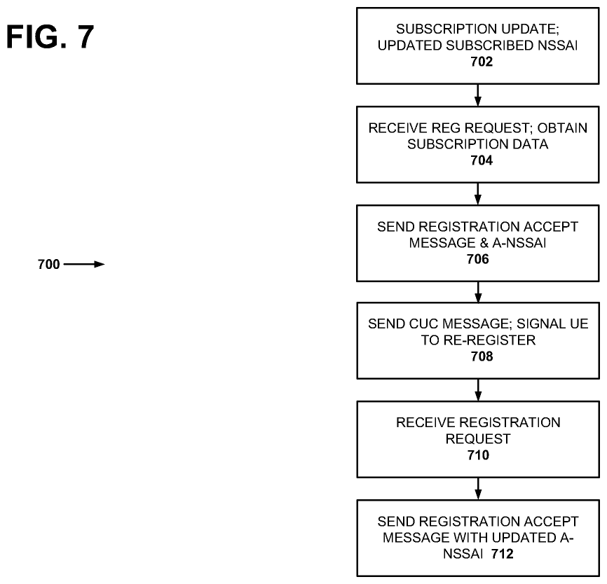

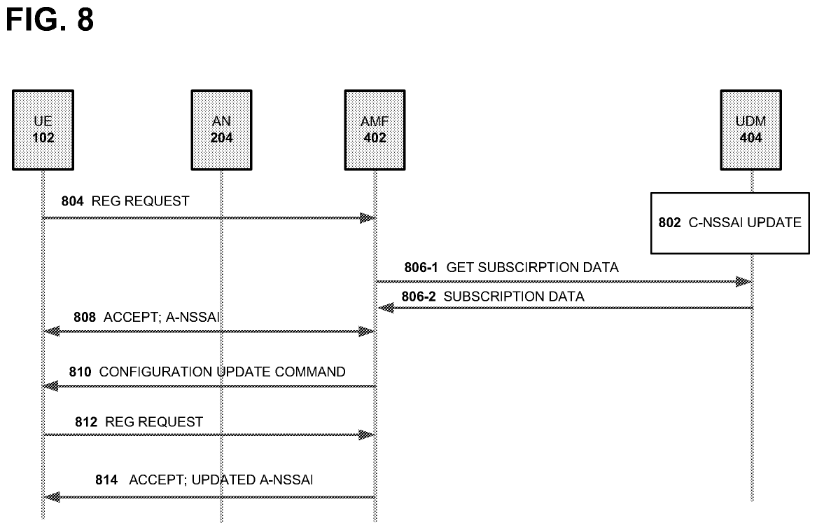

FIG. 7 is a flow diagram of an exemplary process 700 for synchronizing the A-NSSAI with the C-NSSAI at UE 102, according to another implementation. FIG. 8 is a messaging diagram which is associated with process 700. FIG. 8 is described below in connection with FIG. 7. Process 700 may be performed by one or more components and devices of the system for synchronizing the A-NSSAI with the C-NSSAI at UE 102. Depending on the implementation, the system for synchronizing the A-NSSAI and C-NSSAT at UE 102 may perform process 700, process 500, or a combination of portions of process 500 and process 700. As shown in FIG. 7, process 700 may include updating user subscription data at UDM 404 (block 702). The subscription update may include changes in the identities of network slices 212 to which UE 102 is subscribed (block 702; block 802 of FIG. 8).

Process 700 may further include AMF 402 receiving a registration request from UE 102 (block 704; arrow 804). In response to the receipt, AMF 402 may send a request for subscription data to UDM 404 and obtain subscription data from UDM 404 (block 704; arrows 806-1 and 806-2). The subscription data may include S-NSSAI or C-NSSAI that captures any changes to identities of subscribed network slices or of unsubscribed network slices. Thereafter, assuming that any authentication of UE 102 for the registration is successful, AMF 402 may send a registration accept message to UE 102, along with the A-NSSAI (block 706; arrow 808).

Process 700 may further include AMF 402 sending a Configuration Update Command message to UE 102 (block 708; arrow 810). That is, when AMF 402 receives any changes to the identities of subscribed network slices for the UE 102, AMF 402 may notify UE 102 of the changes sending the Configuration Update Command, along with the C-NSSAI. In some implementations, after AMF 402 sends the Configuration Update Command, AMF 402 may signal UE 102 to re-register if the Configuration Update Command includes changes to the C-NSSAI (block 708). In other implementations, UE 102 may include logic (e.g., NSSAI sync logic 312) to re-register at network 104 when UE 102 determines that it has received changes to the C-NSSAI. In either case, UE 102 may generate a registration request. Because UE 102 has detected changes to the C-NSSAI, however, UE 102 may also generate an updated R-NSSAI (requested NSSAI) based on its C-NSSAI.

Process 700 may further include AMF 402 receiving the registration request along with the updated R-NSSAI from UE 102 (block 710; arrow 812). AMF 402 may generate its A-NSSAI partly based on R-NSSAI. AMF 402 may send the updated A-NSSAI along with the registration accept message to UE 102 (block 712; arrow 814). UE 102 may then store the A-NSSAI, thus synchronizing it with its C-NSSAI.

FIG. 9 depicts exemplary components of an exemplary network device 900. Network device 900 may correspond to or be included in any of the devices and/or components illustrated in FIGS. 1-4, 6, and 8 (e.g., UE 102, access network 204, core network 206, data network 208, access station 210, AMF 402, UDM 404, PCF 406, and OTA 408). In some implementations, network devices 900 may be part of a hardware network layer on top of which other network layers and network functions (NFs) may be implemented.

As shown, network device 900 may include a processor 902, memory/storage 904, input component 906, output component 908, network interface 910, and communication path 912. In different implementations, network device 900 may include additional, fewer, different, or different arrangement of components than the ones illustrated in FIG. 9. For example, network device 900 may include line cards, switch fabrics, modems, etc.

Processor 902 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 900 and/or executing programs/instructions.

Memory/storage 904 may include static memory, such as read only memory (ROM), and/or dynamic memory, such as random access memory (RAM), or onboard cache, for storing data and machine-readable instructions (e.g., programs, scripts, etc.). Memory/storage 904 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 904 may be external to and/or removable from network device 900. Memory/storage 904 may include, for example, a Universal Serial Bus (USB) memory stick, a dongle, a hard disk, off-line storage, a Blu-Ray® disk (BD), etc. Memory/storage 904 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 906 and output component 908 may provide input and output from/to a user to/from network device 900. Input/output components 906 and 908 may include a display screen, a keyboard, a mouse, a speaker, a microphone, a camera, a DVD reader, USB lines, and/or other types of components for obtaining, from physical events or phenomena, to and/or from signals that pertain to network device 900.

Network interface 910 may include a transceiver (e.g., a transmitter and a receiver) for network device 900 to communicate with other devices and/or systems. For example, via network interface 910, network device 900 may communicate over a network, such as the Internet, an intranet, cellular, a terrestrial wireless network (e.g., a WLAN, WIFI, WIMAX, etc.), a satellite-based network, optical network, etc. Network interface 910 may include a modem, an Ethernet interface to a LAN, and/or an interface/connection for connecting network device 900 to other devices (e.g., a Bluetooth interface).

Communication path or bus 912 may provide an interface through which components of network device 900 can communicate with one another.

Network device 900 may perform the operations described herein in response to processor 902 executing software instructions stored in a non-transient computer-readable medium, such as memory/storage 904. The software instructions may be read into memory/storage 904 from another computer-readable medium or from another device via network interface 910. The software instructions stored in memory/storage 904, when executed by processor 902, may cause processor 902 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 5-8, the order of the actions, messages, signals may be modified in other implementations. In addition, non-dependent actions, messages, and signals may represent actions, messages, and signals that can be performed, sent, and/or received in parallel and in different orders. Furthermore, each actions, messages, and signals illustrated may include one or more other actions, messages, and/or signals.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code-it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising:
a processor configured to:
forward, to a User Equipment device (UE) over a network, an updated list of subscribed network slices;
receive, from the UE, a registration request that includes a list of requested network slices;
generate, based on the list of requested network slices, an updated list of allowed network slices; and
send the updated list of allowed network slices to the UE, wherein the updated list of allowed network slices is synchronized to the updated list of subscribed network slices.

2. The device of claim 1, wherein the device includes an Access and Mobility Management Function (AMF), wherein when forwarding the updated list of subscribed network slices, the processor is configured to:
send a Configuration Update Command to the UE.

3. The device of claim 1, wherein the updated list of subscribed network slices includes:
Network Slice Selection Assistance Information (NSSAI); or
a Single-NSSAI (S-NSSAI).

4. The device of claim 1, wherein the processor is further configured to:
request subscription data from a Unified Data Management (UDM); and
receive an indications of a change to subscription to a network slice.

5. The device of claim 1, wherein the processor is further configured to:
in response to forwarding the updated list of subscribed network slices, send an instruction to the UE to re-register at the device.

6. The device of claim 1, wherein the processor is configured to:
after forwarding the updated list of subscribed network devices, not send an instruction to the UE to register at the device, prior to receiving, from the UE, the registration request.

7. The device of claim 1, wherein the processor is configured to signal a network component to:
generate an updated UE Route Selection Policy (URSP) rule that includes a Single-Network Slice Selection Assistance Information (S-NSSAI); and
download the updated USRP rule to the UE.

8. The device of claim 7, wherein the UE is configured to:
evaluate the updated URSP rule, wherein when the UE evaluates the URSP rule, the UE obtains an identifier for a network slice specified in the list of requested network slices.

9. The device of claim 1, wherein the updated list of allowed network slices is a subset of the updated list of subscribed network slices.

10. The device of claim 1, wherein when sending the updated list of allowed network slices, the processor is configured to:
send a registration accept message to the UE.

11. A method comprising:
forwarding, to a User Equipment device (UE) over a network, an updated list of subscribed network slices;
receiving, from the UE, a registration request that includes a list of requested network slices;
generating, based on the list of requested network slices, an updated list of allowed network slices; and
sending the updated list of allowed network slices to the UE, wherein the updated list of allowed network slices is synchronized to the updated list of subscribed network slices.

12. The method of claim 11, wherein forwarding the updated list of subscribed network slices includes:
sending a Configuration Update Command to the UE.

13. The method of claim 11 wherein the updated list of subscribed network slices includes:
Network Slice Selection Assistance Information (NSSAI); or
a Single-NSSAI (S-NSSAI).

14. The method of claim 11, further comprising:
requesting subscription data from a Unified Data Management (UDM); and
receiving an indications of a change to subscription to a network slice.

15. The method of claim 11, further comprising;
in response to forwarding the updated list of subscribed network slices, sending an instruction to the UE to re-register.

16. The method of claim 11, further comprising:
after forwarding the updated list of subscribed network devices, not sending an instruction to the UE to register at the device, prior to receiving, from the UE, the registration request.

17. The method of claim 11, further comprising:
signaling a network component to:
generate an updated UE Route Selection Policy (URSP) rule that includes a Single-Network Slice Selection Assistance Information (S-NSSAI); and
download the updated USRP rule to the UE.

18. The method of claim 17, wherein the UE is configured to:
evaluate the updated URSP rule, wherein when the UE evaluates the URSP rule, the UE obtains an identifier for a network slice specified in the list of requested network slices.

19. A non-transitory computer-readable medium comprising processor-executable instructions, which when executed by a processor, cause the processor to:
forward, to a User Equipment device (UE) over a network, an updated list of subscribed network slices;
receive, from the UE, a registration request that includes a list of requested network slices;
generate, based on the list of requested network slices, an updated list of allowed network slices; and
send the updated list of allowed network slices to the UE, wherein the updated list of allowed network slices is synchronized to the updated list of subscribed network slices.

20. The non-transitory computer-readable medium of claim 19, wherein the updated list of subscribed network slices includes:
Network Slice Selection Assistance Information (NSSAI); or
a Single-NSSAI (S-NSSAI).
